(19) United States
(12) Patent Application Publication
(10) Pub. No.: US 2019/0341854 A1
(43) Pub. Date: Nov. 7, 2019

(54) SWITCHING POWER SUPPLY DEVICE

(71) Applicant: Omron Corporation, Kyoto (JP)

(72) Inventor: Yuji Kohara, Aichi (JP)

(73) Assignee: Omron Corporation, Kyoto (JP)

(21) Appl. No.: 16/405,111

(22) Filed: May 7, 2019

(30) Foreign Application Priority Data
May 7, 2018 (JP) 2018-089093

(51) Int. Cl. H02M 3/335; H02M 1/08

(52) U.S. Cl. CPC H02M 3/33569; H02M 2001/0035; H02M 1/08

(57) ABSTRACT

A switching power supply device includes: an inverter circuit including an upper side first switching element and a lower side second switching element connected in series; a control unit; and a bootstrap capacitor that is charged during a period in which the second switching element is turned on and that serves as a power supply configured to turn on the first switching element during a period in which the second switching element is turned off. In a burst mode at a light load, the control unit provides only the first switching element with a pause period in which a state of a switching element becomes an off-state for a certain amount of time, such that the first switching element performs the switching operation intermittently.

### CROSS-REFERENCES TO RELATED APPLICATIONS

This application is based upon and claims the benefit of priority from Japanese Patent Application No. 2018-089093, filed on May 7, 2018; the entire contents of which are incorporated herein by reference.

### FIELD

One or more embodiments of the present invention relate to a switching power supply device including an inverter circuit for switching a voltage of a direct current (DC) power supply and supplying the same to a load side.

### BACKGROUND

For example, a vehicle is equipped with a switching power supply device such as a DC-DC converter which converts a DC voltage of a high voltage battery (DC power supply) to a low voltage and supplies the low voltage to an in-vehicle apparatus or the like. Generally, a DC-DC converter includes an inverter circuit having a pair of switching elements connected in series between a positive electrode and a negative electrode of a battery, a driving circuit for driving the inverter circuit, and a control unit for controlling the driving circuit.

The driving circuit drives each switching element of the inverter circuit based on a pulse width modulation (PWM) signal given from the control unit. Each switching element is turned on/off in a complementary manner by the PWM signal to perform a switching operation. When an upper side switching element is turned on, a lower side switching element is turned off, and when the lower side switching element is turned on, the upper side switching element is turned off. The DC voltage of the battery is converted to an alternating current (AC) voltage by the switching operation of each switching element. The AC voltage passes through a transformer and a rectifying/smoothing circuit, and is converted into a DC voltage of a predetermined level. Thereafter, the DC voltage is supplied to the load.

In the above-described DC-DC converter, since the upper side switching element and the lower side switching element are connected in series, in a state in which the lower side switching element is turned off, an electric potential of one end of the upper side switching element (connection point with the lower side switching element) floats from the ground, and the upper side switching element cannot be turned on. Therefore, a bootstrap capacitor that is charged during the period in which the lower side switching element is turned on is provided, and when the lower side switching element is turned off, the upper side switching element is turned on by the voltage charged in the bootstrap capacitor. A switching power supply device including such a bootstrap capacitor is disclosed in, for example, JP-A-2000-92822, Japanese Patent No. 5750799, and JP-A-2003-61363.

In addition to a normal mode in which the switching operation is continuously performed, the DC-DC converter includes a burst mode in which the switching operation is intermittently performed at a light load with a small load current. In the burst mode, a pause period in which the switching element is maintained in an off-state for a certain amount of time and a switching period in which the switching element performs an on/off switching operation for a certain amount of time, are repeated alternately. By providing the pause period of switching, the switching loss at a light load can be reduced and a voltage conversion efficiency can be enhanced. A switching power supply device having such a burst mode is disclosed in, for example, JP-A-2017-192210.

### SUMMARY

In the switching power supply device having the bootstrap capacitor described above, both the upper side switching element and the lower side switching element become an off-state during the pause period in the burst mode, so that the electric charge of the bootstrap capacitor decreases during the period. Therefore, there is a possibility that the voltage of the capacitor becomes insufficient and the upper side switching element is not turned on when the pause period ends and the transition to the switching period is performed.

An object of one or more embodiments of the invention is to provide a switching power supply device in which a voltage of a bootstrap capacitor is secured in the burst mode so as to avoid troubles in the switching operation.

A switching power supply device according to one or more embodiments of the invention includes an inverter circuit that has an upper side first switching element and a lower side second switching element connected in series; a control unit configured to control on/off operations of the first switching element and the second switching element; and a bootstrap capacitor that is charged during a period in which the second switching element is turned on and that serves as a power supply configured to turn on the first switching element during a period in which the second switching element is turned off. The inverter circuit is provided between a positive electrode and a negative electrode of a direct current power supply. The first switching element and the second switching element are turned on/off in a complementary manner to perform a switching operation, and by the switching operation, a voltage of the direct current power supply is switched and the voltage is supplied to a load. In a burst mode at a light load, the control unit provides only the first switching element with a pause period in which a state of a switching element becomes an off-state for a certain amount of time, such that the first switching element performs the switching operation intermittently.

With such a configuration, only the upper side first switching element is provided with the pause period in the burst mode. Since the pause period is not provided in the lower side second switching element, the bootstrap capacitor can be charged by the second switching element which operates during the pause period of the first switching element. Therefore, when securing a charging voltage of the bootstrap capacitor and shifting from the pause period to the switching period, it is possible to reliably turn on the upper side first switching element and to avoid troubles in the switching operation.

In one or more embodiments of the invention, the control unit may cause the second switching element to perform the switching operation during the pause period of the first switching element. Alternatively, the control unit may set the second switching element to an on-state during the pause period of the first switching element.

In one or more embodiments of the invention, a plurality of pause periods of the first switching element may be provided, and the control unit may cause the second switching element to perform the switching operation in some pause periods and set the second switching element to the on-state in other pause periods.

According to one or more embodiments of the invention, it is possible to provide a switching power supply device in which a voltage of a bootstrap capacitor is secured in the burst mode so as to avoid troubles in the switching operation.

### BRIEF DESCRIPTION OF DRAWINGS

FIG. 1 is a circuit diagram of a DC-DC converter according to an embodiment of the invention FIG. 2 is a circuit diagram illustrating an operation of a bootstrap capacitor FIG. 3 is a circuit diagram illustrating an operation of a bootstrap capacitor.

FIG. 4 is a circuit diagram illustrating an operation of a bootstrap capacitor.

FIG. 5 is a time chart at the start of operation of the DC-DC converter and when it is in a normal mode.

FIG. 6 is a time chart in a burst mode according to the related art.

FIG. 7 is a time chart in a burst mode according to an embodiment of the invention.

FIG. 8 is another example of a time chart in a burst mode.

FIG. 9 is still another example of a time chart in a burst mode.

FIG. 10 is a circuit diagram of the DC-DC converter according to another embodiment of the invention.

### DETAILED DESCRIPTION

In embodiments of the invention, numerous specific details are set forth in order to provide a thorough understanding of the invention. However, it will be apparent to one of ordinary skill in the art that the invention may be practiced without these specific details. In other instances, well-known features have not been described in detail to avoid obscuring the invention.

One or more embodiments of the inventions will be described with reference to the drawings. In each figure, the same reference numerals are attached to the same parts or corresponding parts.

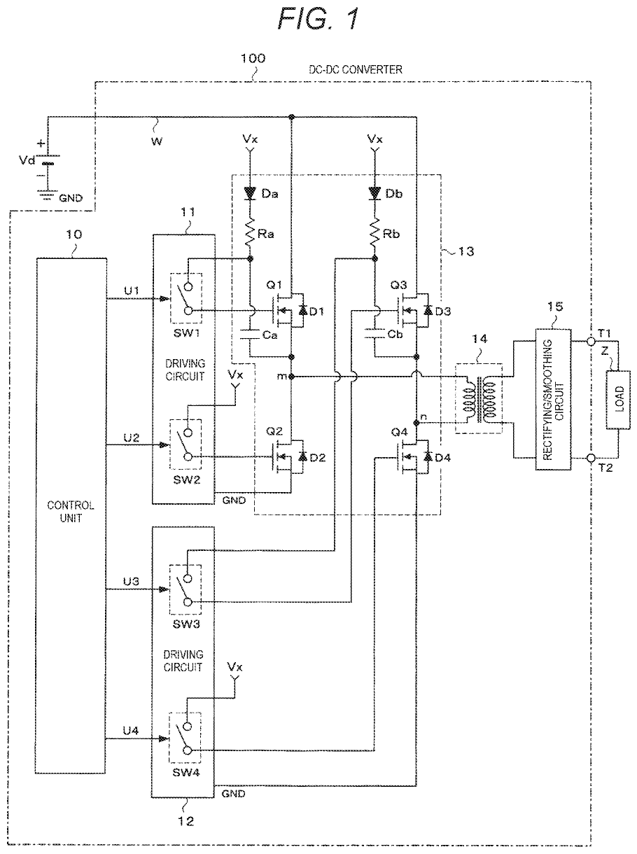

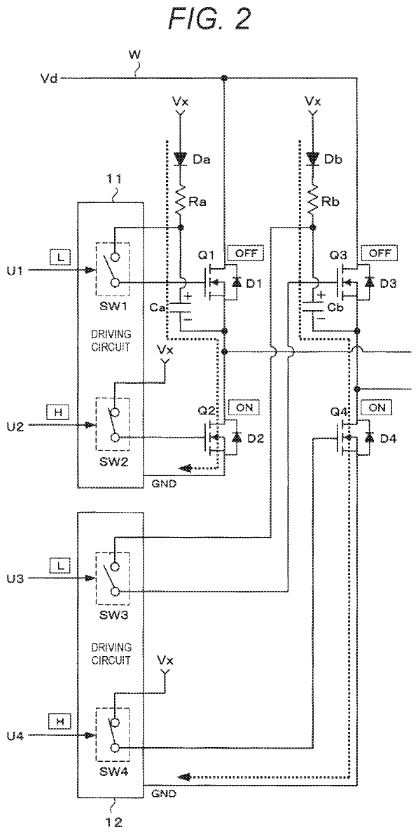

First, the configuration of the switching power supply device of one or more embodiments of the inventions will be described with reference to FIG. 1. In the following, as an example of the switching power supply device, a DC-DC converter mounted in a vehicle is taken as an example.

In FIG. 1, a DC-DC converter 100 is provided between a DC power supply Vd and a load Z, converts a voltage of the DC power supply Vd to a voltage of a predetermined level, and supplies the voltage to the load Z. In this example, the DC power supply Vd is a high-voltage battery mounted in a vehicle, and the load Z is an in-vehicle apparatus, a low-voltage battery, or the like. A positive electrode (+) of the DC power supply Vd is connected to a power supply line W and a negative electrode (−) of the DC power supply Vd is grounded to a ground GND.

The DC-DC converter 100 includes a control unit 10, a driving circuit 11, a driving circuit 12, an inverter circuit 13, a transformer 14, and a rectifying/smoothing circuit 15.

The inverter circuit 13 is provided between the positive electrode (power supply line W) and the negative electrode (ground GND) of the DC power supply Vd, and includes switching elements Q1 to Q4, diodes Da and Db, resistors Ra and Rb, and a bootstrap capacitor Ca and Cb.

In this example, the switching elements Q1 to Q4 are constituted by MOS type FETs, and parasitic diodes D1 to D4 are connected between the respective sources and drains thereof. The switching elements Q1 and Q2 are connected in series between the power supply line W and the ground GND. A drain of the upper side switching element Q1 is connected to the power supply line W. A source of the switching element Q1 is connected to a drain of the lower side switching element Q2. A source of the switching element Q2 is connected to the ground GND.

The switching elements Q3 and Q4 are also connected in series between the power supply line W and the ground GND. A drain of the upper side switching element Q3 is connected to the power supply line W. A source of the switching element Q3 is connected to a drain of the lower side switching element Q4. A source of the switching element Q4 is connected to the ground GND.

An anode of the diode Da is connected to an auxiliary power supply Vx obtained from the DC power supply Vd. A cathode of the diode Da is connected to one end of the resistor Ra. The other end of the resistor Ra is connected to one end of the bootstrap capacitor Ca. The other end of the bootstrap capacitor Ca is connected to the source of the switching element Q1.

An anode of the diode Db is connected to an auxiliary power supply Vx. A cathode of the diode Db is connected to one end of the resistor Rb. The other end of the resistor Rb is connected to one end of the bootstrap capacitor Cb. The other end of the bootstrap capacitor Cb is connected to the source of the switching element Q3.

A connection point m of the switching elements Q1 and Q2 is connected to one end of a primary winding of the transformer 14. A connection point n of the switching elements Q3 and Q4 is connected to the other end of the primary winding of the transformer 14. A secondary winding of the transformer 14 is connected to output terminals T1 and T2 via the rectifying/smoothing circuit 15. The rectifying/smoothing circuit 15 is configured with a diode, an inductance, a capacitor, or the like (not shown). The load Z is connected to the output terminals T1 and T2.

The driving circuit 11 is a circuit for turning on/off the switching elements Q1 and Q2, and has switches SW1 and SW2. For convenience sake, the switches SW1 and SW2 are represented by symbols of contact switches, but these switches are actually configured by semiconductor elements (the same applies to switches SW3 and SW4 to be described later). One end of the switch SW1 is connected to a connection point between the resistor Ra and the bootstrap capacitor Ca. The other end of the switch SW1 is connected to a gate of the switching element Q1. One end of the switch SW2 is connected to an auxiliary power supply Vx. The other end of the switch SW2 is connected to a gate of the switching element Q2.

The driving circuit 12 is a circuit for turning on/off the switching elements Q3 and Q4, and has switches SW3 and SW4. One end of the switch SW3 is connected to a connection point between the resistor Rb and the bootstrap capacitor Cb. The other end of the switch SW3 is connected to a gate of the switching element Q3. One end of the switch SW4 is connected to an auxiliary power supply Vx. The other end of the switch SW4 is connected to a gate of the switching element Q4.

The control unit 10 is configured to a microcomputer, and controls on/off operations of the switching elements Q1 to Q4 via the driving circuits 11 and 12. More specifically, a control signal U1 for controlling an operation of the switch SW1 and a control signal U2 for controlling an operation of the switch SW2 are given from the control unit 10 to the driving circuit 11. In the present example, these control signals U1 and U2 are pulse width modulation (PWM) signals. When the PWM signal is “H” (High), the switches SW1 and SW2 are turned on, and when the PWM signal is “L” (Low), the switches SW1 and SW2 are turned off. When the switch SW1 is turned on, a voltage of the auxiliary power supply Vx is applied to the gate of the switching element Q1 via the diode Da and the resistor Ra, and the switching element Q1 is turned on. When the switch SW2 is turned on, a voltage of the auxiliary power supply Vx is applied to the gate of the switching element Q2, and the switching element Q2 is turned on.

A control signal U3 for controlling an operation of the switch SW3 and a control signal U4 for controlling an operation of the switch SW4 are given from the control unit 10 to the driving circuit 12. These control signals U3 and U4 are also PWM signals. When the PWM signal is “H”, the switches SW3 and SW4 are turned on, and when the PWM signal is “L”, the switches SW3 and SW4 are turned off. When the switch SW3 is turned on, a voltage of the auxiliary power supply Vx is applied to the gate of the switching element Q3 via the diode Db and the resistor Rb, and the switching element Q3 is turned on. When the switch SW4 is turned on, a voltage of the auxiliary power supply Vx is applied to the gate of the switching element Q4, and the switching element Q4 is turned on.

The bootstrap capacitor Ca is a capacitor that is charged during a period in which the lower side switching element Q2 is turned on and serves as a power supply for turning on the upper side switching element Q1 during a period in which the switching element Q2 is turned off. The bootstrap capacitor Cb is a capacitor that is charged during a period in which the lower side switching element Q4 is turned on and serves as a power supply for turning on the upper side switching element Q3 during a period in which the switching element Q4 is turned off.

In the above configuration, the upper side switching elements Q1 and Q3 are examples of the “first switching element” in the embodiment of the invention and the lower side switching elements Q2 and Q4 are examples of the “second switching element” in the embodiment of the invention.

Next, the operation of the DC-DC converter 100 of FIG. 1 will be described.

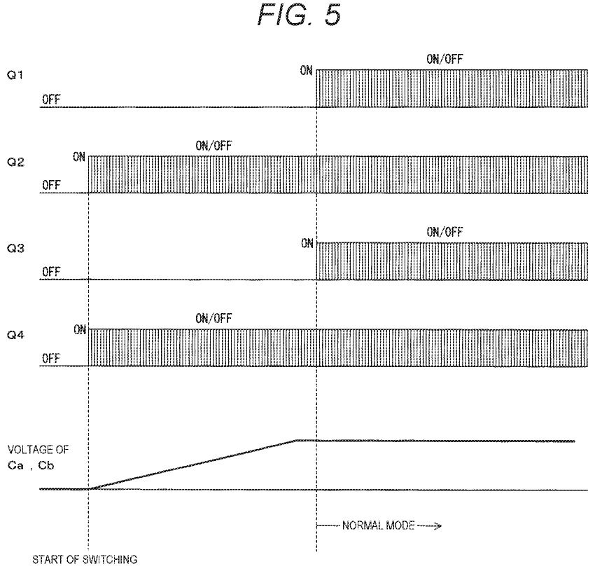

As shown in FIG. 5, at the start of switching of the inverter circuit 13, the upper side switching elements Q1 and Q3 are maintained in an off-state and the lower side switching elements Q2 and Q4 are turned on/off. In this case, in FIG. 1, the control signals U1 and U3 from the control unit 10 are maintained “L”, and the control signals U2 and U4 become the PWM signals in which “H” and “L” are switched.

As shown in FIG. 2, when the control signals U2 and U4 are “H”, the switches SW2 and SW4 are turned on and the lower side switching elements Q2 and Q4 are turned on. During the on period, the bootstrap capacitors Ca. and Cb are charged in paths indicated by dotted lines. As shown in FIG. 3, when the control signals U2 and U4 are “L”, the switches SW2 and SW4 are turned off and the lower side switching elements Q2 and Q4 are turned off. During the off period, the bootstrap capacitors Ca and Cb are not charged. As the switching elements Q2 and Q4 repeat turning on/off, the voltage across the bootstrap capacitors Ca and Cb rises gradually as shown in FIG. 5.

In this way, when charging the bootstrap capacitors Ca and Cb at the start of switching, the lower side switching elements Q2 and Q4 are switched (on/off) without being fixed in an on-state in order to suppress an inrush current to the bootstrap capacitors Ca and Cb. After the voltage across the bootstrap capacitors Ca and Cb reaches a certain level, the upper side switching elements Q1 and Q3 start the switching operation and a mode is shifted to a normal mode as shown in FIG. 5.

In the normal mode, when the upper side switching element Q1 is turned on, the lower side switching element Q2 is turned off, and when the upper side switching element Q1 is turned off, the lower side switching element Q2 is turned on. That is, the upper side and the lower side switching elements Q1 and Q2 are turned on/off in a complementary manner to perform the switching operation. Similarly, when the upper side switching element Q3 is turned on, the lower side switching element Q4 is turned off, and when the upper side switching element Q3 is turned off, the lower side switching element Q4 is turned on. That is, the upper side and the lower side switching elements Q3 and Q4 are also turned on/off in a complementary manner to perform the switching operation.

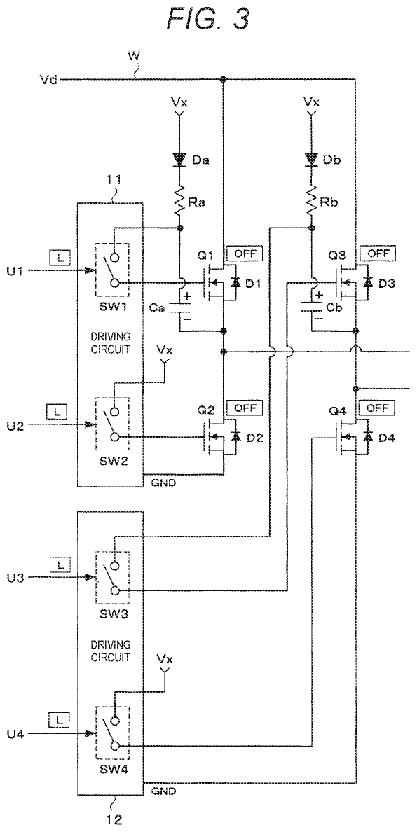

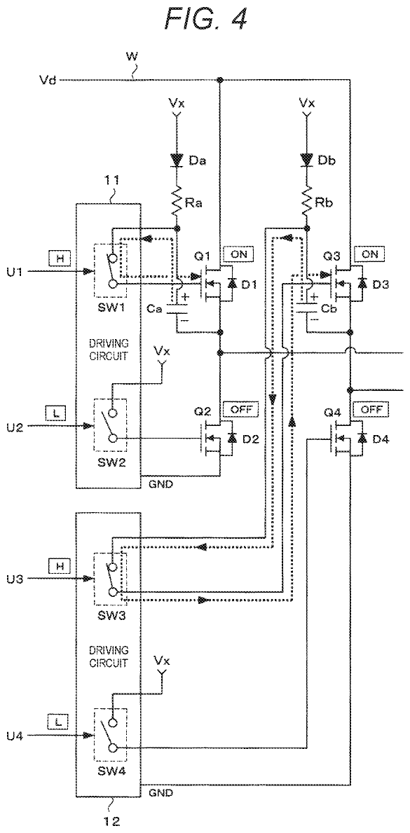

In this case, as shown in FIG. 4, during a period when the lower side switching element Q2 is turned off, the voltage of the bootstrap capacitor Ca is applied between the gate and the source of the switching element Q1 via the switch SW1 of the driving circuit 11 in the on-state and the switching element Q1 is turned on by using the voltage of the capacitor Ca as a power supply. Similarly, during a period when the lower side switching element Q4 is turned off, the voltage of the bootstrap capacitor Cb is applied between the gate and the source of the switching element Q3 via the switch SW3 of the driving circuit 12 in the on-state and the switching element Q3 is turned on by using the voltage of the capacitor Cb as a power supply.

By the switching operation of the switching elements Q1 to Q4 as described above, the DC voltage of the DC power supply Vd is switched to an AC voltage. The AC voltage is converted into a low-voltage DC voltage by the transformer 14 and the rectifying/smoothing circuit 15, and the low-voltage DC voltage is supplied to the load Z connected to output terminals T1 and T2.

Next, the operation in the burst mode will be described. As described above, the burst mode is a mode in which the switching operation of the inverter circuit 13 is intermittently performed at a light load, that is, when a current flowing to the load Z is small. By decreasing a duty of the PWM signals (control signals U1 to U4) given from the control unit 10 to the driving circuits 11 and 12, the on period of the switching elements Q1 to Q4 is shortened and the current flowing to the load Z is reduced. Therefore, when the duty of the PWM signal becomes equal to or less than a predetermined value, the control unit 10 switches an operation mode from the normal mode to the burst mode.

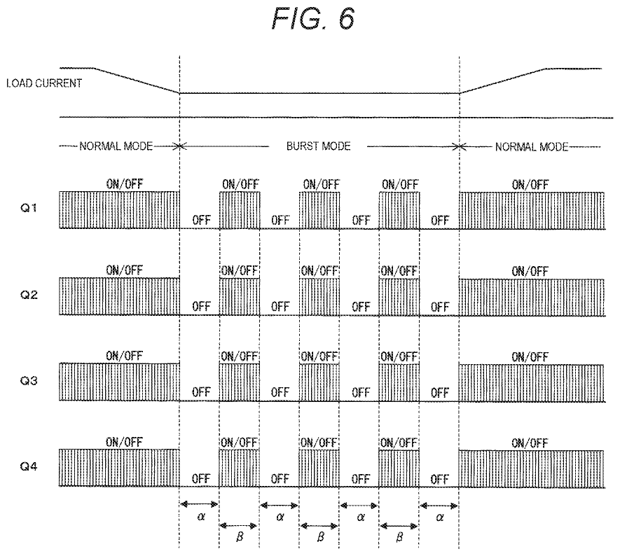

FIG. 6 is a time chart indicating the switching operation in a burst mode according to the related art. In the normal mode, the switching operation by turning on/off the switching elements Q1 to Q4 is continuously performed. However, when shifting to the burst mode, a pause period β, in which each of the switching elements Q1 to Q4 is in the off-state for a certain amount of time and a switching period β in which each of the switching elements Q1 to Q4 performs the switching operation for a certain amount of time, are repeated alternately.

As shown in FIG. 6, in the related art, the pause period α is provided for all of the four switching elements Q1 to Q4 in the burst mode. In the pause period α, when the upper side switching elements Q1 and Q3 are turned off, the lower side switching elements Q2 and Q4 are also turned off, and the bootstrap capacitors Ca and Cb are not charged. Therefore, electric charges of the bootstrap capacitors Ca and Cb decrease due to the discharge, and the voltage of the capacitor lowers. As a result, there is a possibility that the voltages of the bootstrap capacitors Ca and Cb are insufficient and the upper side switching elements Q1 and Q3 are not turned on when shifting from the pause period α to the switching period β.

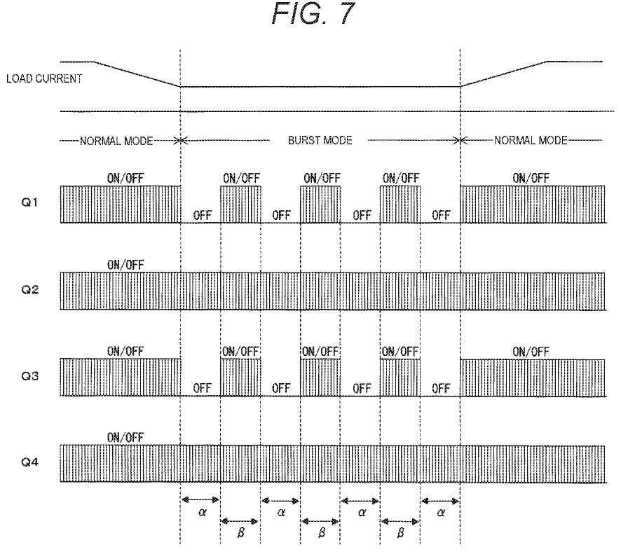

In contrast to this, in the embodiment of the invention, as shown in FIG. 7, as for the burst mode, the pause period α is provided only in the upper side switching elements Q1 and Q3, and the elements Q1 and Q3 intermittently perform the switching operation. Further, the lower side switching elements Q2 and Q4 continuously perform the switching operation without providing the pause period α. That is, the lower side switching elements Q2 and Q4 continue the switching operation even during the pause period α of the upper side switching elements Q1 and Q3.

In order to perform such operation, the control unit 10 (FIG. 1) sets the control signals U1 and U3 to “L” during the pause period α to turn off the switches SW1 and SW3 of the driving circuits 11 and 12, and maintains the upper side switching elements Q1 and Q3 in the off-state. In addition, the control unit 10 sets the control signals U2 and U4 to the PWM signals of “H” and “L” during the pause period α to turn on/off the switches SW2 and SW4 of the driving circuits 11 and 12, and the lower side switching elements Q2 and Q4 perform the switching operation.

In an above-described manner, in the burst mode, the upper side switching elements Q1 and Q3 intermittently perform the switching operation with having the pause period α (off period), while the lower side switching elements Q2 and Q4 continuously perform the switching operation without having the pause period α. Therefore, in the pause period α, the bootstrap capacitors Ca and Cb can be charged in a section in which the elements Q2 and Q4 are turned on by the switching operation of the lower side switching elements Q2 and Q4. In this way, the voltages of the bootstrap capacitors Ca and Cb are maintained at a certain level or higher, so that the upper side switching elements Q1 and Q3 can reliably be turned on when shifting from the pause period α to the switching period 3.

In the pause period α, the lower side switching elements Q2 and Q4 perform the switching operation without being fixed to the on-state. Therefore, it is possible to avoid a short circuit fault in which the upper side switching elements Q1 and Q3, and the lower side switching elements Q2 and Q4 are the on-state at the same time, by adjusting the on/off timing.

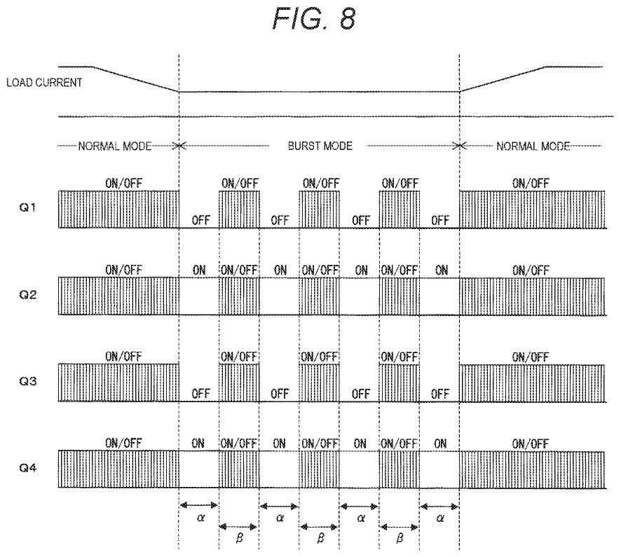

FIG. 8 is a time chart indicating the switching operation in a burst mode according to other embodiment of the invention. In the case of FIG. 7 described above, during the pause period α of the upper side switching elements Q1 and Q3, the lower side switching elements Q2 and Q4 performed the on/off switching operation. In contrast to this, in a case of FIG. 8, during the pause period α of the upper side switching elements Q1 and Q3, the lower side switching elements Q2 and Q4 are maintained the on-state.

In order to perform such operation, the control unit 10 (FIG. 1) sets the control signals U1 and U3 to “L” during the pause period α to turn off the switches SW1 and SW3 of the driving circuits 11 and 12, and maintains the upper side switching elements Q1 and Q3 in the off-state. In addition, the control unit 10 sets the control signals U2 and U4 to “H” during the pause period α to turn on the switches SW2 and SW4 of the driving circuits 11 and 12, and maintains the lower side switching elements Q2 and Q4 in the on-state.

In an above-described manner, in the burst mode, since the lower side switching elements Q2 and Q4 are in the on-state during the pause period α of the upper side switching elements Q1 and Q3, the bootstrap capacitors Ca and Cb are charged during this period. Therefore, as in the case of FIG. 7, the voltages of the bootstrap capacitors Ca and Cb are maintained at a certain level or higher, so that the upper side switching elements Q1 and Q3 can reliably be turned on when shifting from the pause period α to the switching period β.

Note that when the lower side switching elements Q2 and Q4 are fixed in the on-state over the entire section of the pause period α, the upper side and the lower side switching elements are simultaneously turned on at the beginning and the end of the pause period α and a short circuit may occur. Therefore, it is preferable to provide a dead time section at the beginning and the end of the pause period α so as to avoid simultaneous turning on of the upper side and the lower side switching elements.

As described above, in the embodiment of the invention, only the upper side switching elements Q1 and Q3 are provided with the pause period α in the burst mode. Since the pause period α is not provided in the lower side switching elements Q2 and Q4, the bootstrap capacitors Ca and Cb can be charged by the lower side switching elements Q2 and Q4 which operate during the pause period of the switching elements Q1 and Q3. Therefore, when securing the charging voltage of the bootstrap capacitors Ca and Cb and shifting from the pause period α to the switching period β, it is possible to reliably turn on the upper side switching elements Q1 and Q3 and to avoid troubles in the switching operation.

In the embodiment of the invention, in addition to the above description, various embodiments described below can be adopted.

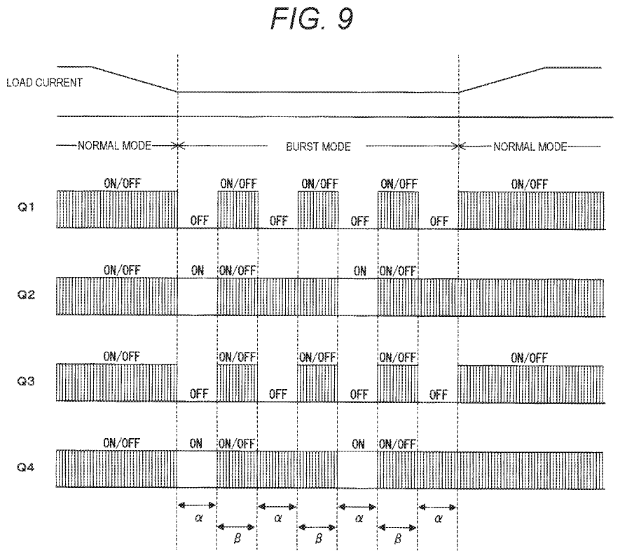

In FIG. 7, the lower side switching elements Q2 and Q4 perform the switching operation during the pause period α of the upper side switching elements Q1 and Q3, and in FIG. 8, the lower side switching elements Q2 and Q4 are maintained in the on-state during the pause period α of the upper side switching elements Q1 and Q3, but the invention is not limited thereto. For example, as shown in FIG. 9, the lower side switching elements Q2 and Q4 may perform the switching operation in some pause periods α among a plurality of pause periods α, and in other pause periods α, the lower side switching elements Q2 and Q4 may be the on-state. That is, as the operation mode of the lower side switching elements Q2 and Q4 in the pause period α, the switching operation and the maintenance of the on-state may be mixed.

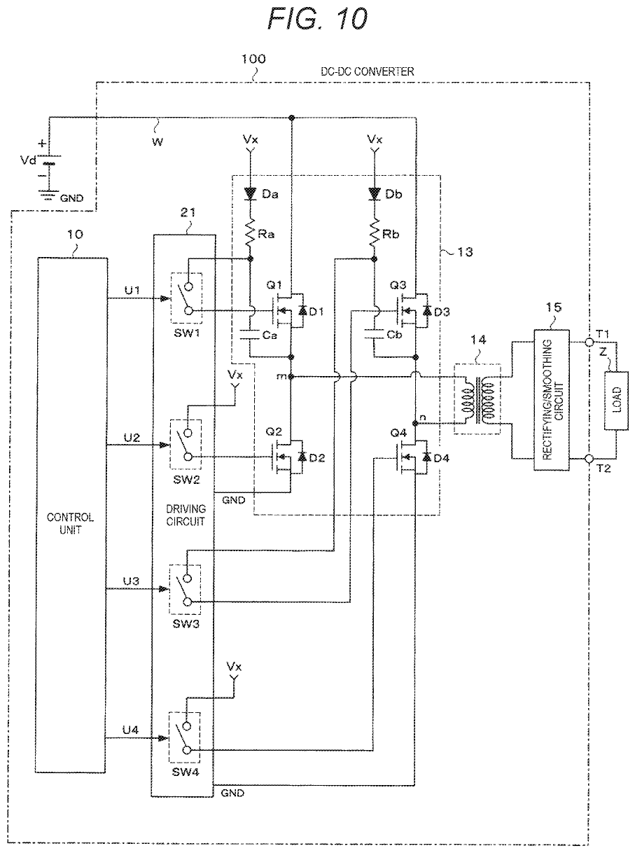

In FIG. 1, the driving circuit 11 for driving the switching elements Q1 and Q2, and the driving circuit 12 for driving the switching elements Q3 and Q4 are provided separately, but the invention is not limited thereto. For example, as shown in FIG. 10, one driving circuit 21 for driving the switching elements Q1 to Q4 may be provided.

In FIGS. 1 and 10, the driving circuits 11, 12, and 21 are provided separately from the control unit 10, but the driving circuits 11, 12, and 21 may be provided inside the control unit 10.

In FIGS. 1 and 10, four switching elements Q1 to Q4 are provided in the inverter circuit 13, and two diodes Da and Db, two resistors Ra and Rb, and two bootstrap capacitors Ca and Cb are provided, but the invention is not limited thereto. For example, only the switching elements Q1 and Q2, one diode Da, one resistor Ra. and one bootstrap capacitor Ca may be provided in the inverter circuit 13.

In the above embodiment, the control unit 10 shifts to the burst mode when the duty of the PWM signal becomes equal to or less than the predetermined value, but the invention is not limited thereto. For example, a current detection circuit for detecting the current flowing through the load Z is provided, and the control unit 10 may shift to the burst mode when a value of the load current detected by the current detection circuit becomes equal to or less than a predetermined value.

In the above embodiment, FETs are used as the switching elements Q1 to Q4. However switching elements such as transistors and IGBTs can be used instead of the FETs.

In the above embodiment, the DC-DC converter 100 mounted on the vehicle is taken as an example. However, one or more embodiments of the invention can also be applied to a DC-DC converter used for applications other than vehicles. Further, one or more embodiments of the invention can be applied not only to a DC-DC converter but also to a switching power supply device such as a DC-AC converter.

While the invention has been described with respect to a limited number of embodiments, those skilled in the art, having benefit of this disclosure, will appreciate that other embodiments can be devised which do not depart from the scope of the invention as disclosed herein. According, the scope of the invention should be limited only by the attached claims.

1. A switching power supply device comprising:
an inverter circuit that is provided between a positive electrode and a negative electrode of a direct current power supply and that comprises an upper side first switching element and a lower side second switching element connected in series;
a control unit configured to control on/off operations of the first switching element and the second switching element; and
a bootstrap capacitor that is charged during a period in which the second switching element is turned on and that serves as a power supply configured to turn on the first switching element during a period in which the second switching element is turned off,
wherein the first switching element and the second switching element are turned on/off in a complementary manner to perform a switching operation, and by the switching operation, a voltage of the direct current power supply is switched and the voltage is supplied to a load, and
wherein in a burst mode at a light load, the control unit provides only the first switching element with a pause period in which a state of a switching element becomes an off-state for a certain amount of time, such that the first switching element performs the switching operation intermittently.

2. The switching power supply device according to claim 1,
wherein the control unit causes the second switching element to perform the switching operation during the pause period of the first switching element.

3. The switching power supply device according to claim 1,
wherein the control unit sets the second switching element to an on-state during the pause period of the first switching element.

4. The switching power supply device according to claim 1,
wherein a plurality of pause periods of the first switching element are provided, and
wherein the control unit causes the second switching element to perform the switching operation in some pause periods, and sets the second switching element to an on-state in other pause periods.
